(19) United States
(12) Patent Application Publication
(10) Pub. No.: US 2024/0329572 A1
(43) Pub. Date: Oct. 3, 2024

(54) HEATING SYSTEM AND IMAGE FORMING SYSTEM

(71) Applicant: FUJIFILM Business Innovation Corp., Tokyo (JP)

(72) Inventor: Kohei TAKAHASHI, Kanagawa (JP)

(73) Assignee: FUJIFILM Business Innovation Corp., Tokyo (JP)

(21) Appl. No.: 18/462,618

(22) Filed: Sep. 7, 2023

(30) Foreign Application Priority Data
Mar. 28, 2023 (JP) 2023-050897

(51) Int. Cl. G03G 15/20

(52) U.S. Cl. CPC G03G 15/2007

(57) ABSTRACT

A heating system includes a heat source configured to heat, in a non-contact manner, an object onto which a toner image has been transferred, a holder configured to hold the object, an adjustment mechanism configured to adjust a distance in a height direction between the heat source and the object, and one or more processors configured to control the adjustment mechanism. The one or more processors are configured to control a height of the holder based on at least one of a thickness or a material of the object prior to heating of the object by the heat source.

### CROSS-REFERENCE TO RELATED APPLICATIONS

This application is based on and claims priority under 35 USC 119 from Japanese Patent Application No. 2023-050897 filed Mar. 28, 2023.

### BACKGROUND

### (i) Technical Field

The present disclosure relates to a heating system and an image forming system.

### (ii) Related Art

There is an image forming apparatus that may transfer a toner image onto the surface of a flat object, a cylindrical object, or any other three-dimensional object. There are various materials for those types of object. Examples of the materials include metal, ceramic, glass, and cloth. In the case of a three-dimensional object, the toner image is fixed by a non-contact heating method.
Japanese Patent No. 6900650 is an example of related art.

### SUMMARY

Aspects of non-limiting embodiments of the present disclosure relate to the following circumstances. A toner image transfer step includes a process of adjusting the height of an object before the start of toner image transfer. However, a fixing step using the non-contact heating method does not include this type of height adjustment. That is, the distance between a holder and a heat source is kept constant. Therefore, the temperature of the object may deviate from an ideal temperature depending on the thickness and material of the object. This temperature deviation may cause a fixing failure.

Aspects of non-limiting embodiments of the present disclosure relate to improvement in toner image fixing performance compared with a case where the distance between the object and the heat source is not adjusted in the fixing step.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a heating system comprising: a heat source configured to heat, in a non-contact manner, an object onto which a toner image has been transferred; a holder configured to hold the object; an adjustment mechanism configured to adjust a distance in a height direction between the heat source and the object; and one or more processors configured to control the adjustment mechanism, wherein the one or more processors are configured to control a height of the holder based on at least one of a thickness or a material of the object prior to heating of the object by the heat source.

### BRIEF DESCRIPTION OF THE DRAWINGS

Exemplary embodiments of the present disclosure will be described in detail based on the following figures, wherein:

FIG. 1 illustrates the overall configuration of an image forming system of a first exemplary embodiment;

FIG. 2 illustrates an example of the configuration of a control panel of the first exemplary embodiment;

FIG. 3 illustrates an example of the configuration of a transfer apparatus of the first exemplary embodiment;

FIG. 4 illustrates an example of the configuration of a heating apparatus;

FIGS. 5A and 5B illustrate ascent and descent of a holder, in which FIG. 5A illustrates the holder that has ascended to the highest point and FIG. 5B illustrates the holder that has descended to the lowest point;

FIGS. 6A and 6B illustrate an example of a jig for attachment of a cylindrical recording medium;

FIG. 7 illustrates an example of a recording medium setting screen displayed on a display of the control panel;

FIGS. 8A to 8C illustrate relationships among a thickness, a width, and a depth for individual types of shape, in which FIG. 8A illustrates a flat plate, FIG. 8B illustrates a box, and FIG. 8C illustrates a can;

FIG. 9 illustrates an example of the setting screen during input;

FIGS. 10A and 10B illustrate items suggested in a pop-up screen, in which FIG. 10A illustrates a case where there is no gap between the recording medium and the surface of the jig and FIG. 10B illustrates a case where there is a gap between the recording medium and the surface of the jig;

FIGS. 11A and 11B illustrate examples of input to the setting screen, in which FIG. 11A illustrates an input example in a case where the recording medium is an aluminum can and FIG. 11B illustrates an input example in a case where the recording medium is a ceramic flat plate;

FIG. 12 is a flowchart illustrating holder height setting to be performed by a processor;

FIG. 13 illustrates an example of a table that records relationships between combinations of the thickness and material of the recording medium and distances from a heat source to an attachment surface;

FIG. 14 is a flowchart illustrating an example of control in a fixing step; and

FIG. 15 illustrates the overall configuration of an image forming system of a second exemplary embodiment.

### DETAILED DESCRIPTION

Exemplary embodiments of the present disclosure are described with reference to the drawings.

### First Exemplary Embodiment

### <System Configuration>

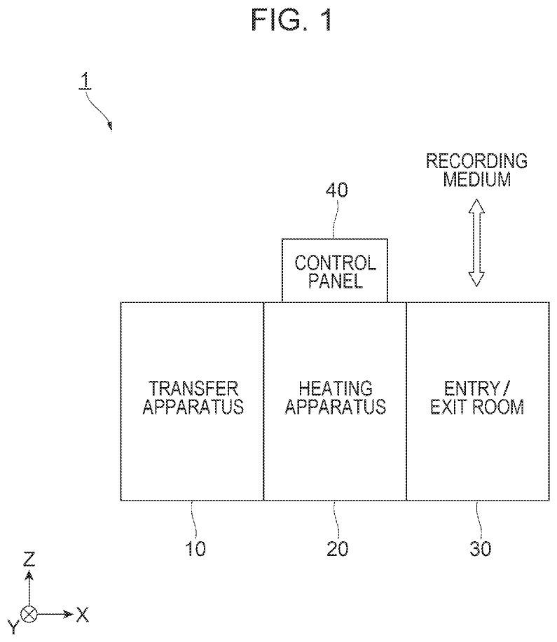

FIG. 1 illustrates the overall configuration of an image forming system 1 of a first exemplary embodiment.

In FIG. 1, the image forming system 1 includes a transfer apparatus 10 that transfers a toner image onto a recording medium, a heating apparatus 20 that fixes the transferred toner image onto the recording medium, an entry/exit room 30, and a control panel 40.

The recording medium is an example of an object onto which a toner image is to be or has been transferred. The recording medium is an example of a heating target.

Materials of the recording medium include metal including aluminum and steel, ceramic, glass, and cloth. Objects made of ceramic are referred to as “ceramics”. Examples the ceramics include a tile.

In this exemplary embodiment, the recording medium is a three-dimensional object to which a toner image is fixed by a non-contact heating method. Examples of the three-dimensional shape include a flat plate, a box, a can, a cylinder, a column, a sphere, and a polyhedron.

In this exemplary embodiment, the transfer apparatus 10, the heating apparatus 20, the entry/exit room 30, and the control panel 40 have independent casings.

In this exemplary embodiment, the casings of the transfer apparatus 10, the heating apparatus 20, and the entry/exit room 30 are connected to each other. The transfer apparatus 10, the heating apparatus 20, and the entry/exit room 30 may be housed in a single casing to apparently constitute a single apparatus.

The internal space of the transfer apparatus 10 and the internal space of the heating apparatus 20 are connected to each other through openings on the sides of the casings. Similarly, the internal space of the heating apparatus 20 and the internal space of the entry/exit room 30 are connected to each other through openings on the sides of the casings. That is, the internal space of the transfer apparatus 10, the internal space of the heating apparatus 20, and the internal space of the entry/exit room 30 are connected to each other to constitute a single internal space. The connected internal spaces are hereinafter referred to as “internal space of image forming system 1”.

In the internal space of the image forming system 1, a transport rail (not illustrated) is attached across the transfer apparatus 10, the heating apparatus 20, and the entry/exit room 30. The recording medium is transported along the transport rail.

A plane that appears in FIG. 1 is referred to as “front”. A plane that is opposite to the front and does not appear in FIG. 1 is referred to as “back”. A YZ plane in FIG. 1 is referred to as “side”. In FIG. 1, the Z-axis direction is referred to as “height”, and the transport of the recording medium in the Z-axis direction is referred to as “ascend/descend”. The transport in an X-axis direction is referred to as “horizontal movement”. A plane defined by an X axis and a Y axis is parallel to a floor.

The transfer apparatus 10 transfers, onto the recording medium, an image (hereinafter referred to as “toner image”) formed with toner or powdery particles (hereinafter referred to also as “toner etc.”). That is, the transfer apparatus 10 of this exemplary embodiment transfers the image by an electrophotographic system.

The heating apparatus 20 fixes the toner image onto the surface of the recording medium by the non-contact heating method. The heating apparatus 20 of this exemplary embodiment has two types of heating method, and may switch the heating methods depending on the material of the recording medium.

One of the heating methods is a method using far-infrared rays (FIR). The other of the heating methods is a method using infrared rays (IR). The heating methods are switched under control of the control panel 40.

In each heating method, the toner image is fixed onto the surface of the recording medium by melting the transferred toner with radiation heat. Both the far-infrared method and the infrared method are categorized into the non-contact heating methods.

The entry/exit room 30 is a box-shaped casing for the recording medium to enter and exit the image forming system 1. In FIG. 1, the entry/exit room 30 has an opening on its top for entry and exit of the recording medium. The recording medium that has entered from the entry/exit room 30 is transported to the transfer apparatus 10 through the heating apparatus 20. When the recording medium is transported to a transfer start position, the transfer apparatus 10 starts to transfer a toner image. When the toner image has been transferred onto the recording medium, the recording medium is transported from the transfer apparatus 10 to the heating apparatus 20. The heating apparatus 20 heats, for a preset period, the recording medium onto which the toner image has been transferred to fix the toner image onto the recording medium. The recording medium onto which the toner image has been fixed is transported from the heating apparatus 20 to the entry/exit room 30, and then exits to an external space.

The control panel 40 is a computer that controls a printing operation of the image forming system 1.

In FIG. 1, the control panel 40 is attached to the top of the casing of the heating apparatus 20.

The control panel 40 may be attached at any position. For example, the control panel 40 may be attached to the top of the transfer apparatus 10 or the entry/exit room 30. The control panel 40 may be integrated with the transfer apparatus 10 or the like.

In this exemplary embodiment, a system including the heating apparatus 20 and a functional part of the control panel 40 that switches the heating method of the heating apparatus 20 is referred to as “heating system”. If the heating apparatus 20 performs the heating method switching control alone, the heating apparatus 20 is referred to as “heating system”.

The control panel 40 may be connected communicably to the transfer apparatus 10, the heating apparatus 20, and the like via a communication line or a network. The network may be a local area network (LAN), the Internet, a cloud network, or a mobile communication system.

In this exemplary embodiment, the control panel 40 has a function of controlling the height of the recording medium prior to the heating of the recording medium by the heating apparatus 20. In this exemplary embodiment, the height of the recording medium is defined by the height of an attachment surface to which the recording medium is attached. The height of the recording medium may be defined by the highest point of the recording medium attached to the attachment surface.

In this exemplary embodiment, the control panel 40 controls the height of the recording medium by ascent and descent of the attachment surface.

### <Configuration of Control Panel>

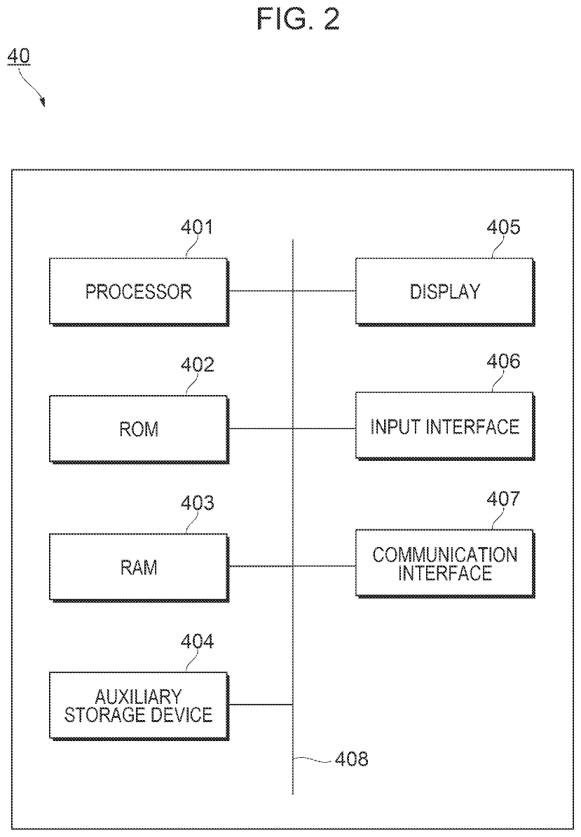

FIG. 2 illustrates an example of the configuration of the control panel 40 of the first exemplary embodiment. In FIG. 2, the control panel 40 includes a processor 401, a read only memory (ROM) 402 that stores a basic input/output system (BIOS) and the like, a random access memory (RAM) 403 serving as a working area for the processor 401, an auxiliary storage device 404, a display 405, an input interface 406, and a communication interface 407. The devices are connected via a bus or other signal lines 408.

The processor 401 is a device that implements various functions by executing programs. The processor 401, the ROM 402, and the RAM 403 function as the computer.

The auxiliary storage device 404 includes, for example, a hard disk drive or a semiconductor storage. The auxiliary storage device 404 stores various types of data on programs. The programs include an OS and application programs.

Examples of the display 405 include a liquid crystal display and an organic electroluminescent (EL) display. The display 405 may be integrated with the control panel 40, provided externally to the control panel 40, or connected by wireless communication.

The input interface 406 receives information from a keyboard, a mouse, and other input devices.

The communication interface 407 is used for communication with, for example, the transfer apparatus 10 (see FIG. 1), the heating apparatus 20 (see FIG. 1), and the entry/exit room 30 (see FIG. 1). The communication interface 407 is compatible with various communication standards in conjunction with signal lines and networks for communication. Examples of the communication standards include a peripheral component interconnect (PCI) bus, a peripheral component interconnect-express (PCIe) bus, and Ethernet (registered trademark).

### <Configuration of Transfer Apparatus>

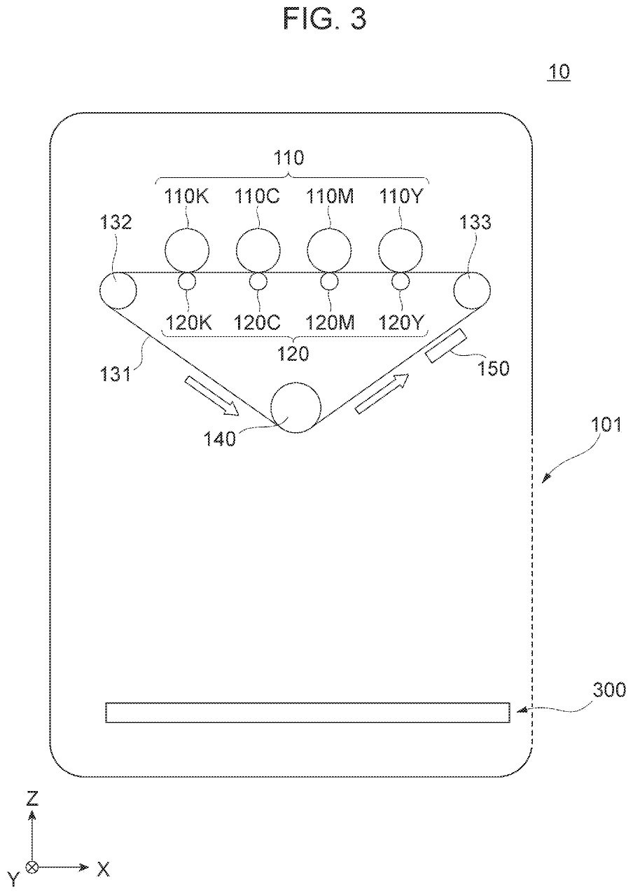

FIG. 3 illustrates an example of the configuration of the transfer apparatus 10 of the first exemplary embodiment.

The transfer apparatus 10 has an opening 101 on the side of the casing for connection to the internal space of the heating apparatus 20 (see FIG. 1).

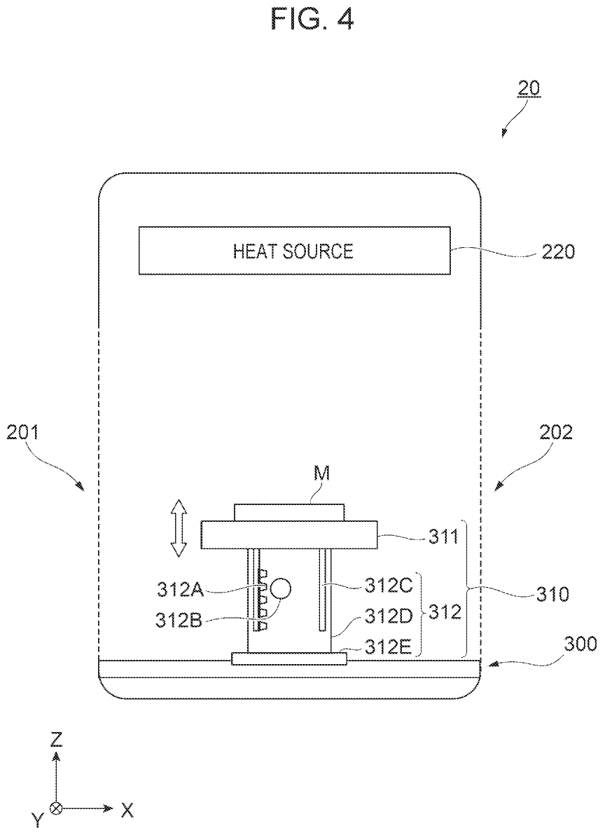

A transport rail 300 is attached to the bottom of the transfer apparatus 10 to transport a transport mechanism 310 described later (see FIG. 4).

A developing device 110, a first transfer roller 120, and an intermediate transfer belt 131 are provided in an upper space of the transfer apparatus 10. The intermediate transfer belt 131 cyclically moves while being looped around drive rollers 132 and 133 and a backup roller 140. The intermediate transfer belt 131 is an example of a transfer belt.

The transfer apparatus 10 includes a cleaning device 150 that removes, from the intermediate transfer belt 131, toner particles remaining on the intermediate transfer belt 131 after passing through a transfer position.

The developing device 110 is a unit that forms an electrostatic latent image of a target image on a photoconductor and causes charged toner particles to adhere to the electrostatic latent image on the photoconductor to develop a toner image. In FIG. 3, the developing device 110 includes subunits for yellow, magenta, cyan, and black.

In FIG. 3, the yellow, magenta, cyan, and black subunits are represented by symbols “Y”, “M”, “C”, and “K” indicating the respective colors.

The first transfer roller 120 is used for transferring the image formed by the developing device 110 onto the intermediate transfer belt 131. The transfer performed by the first transfer roller 120 is referred to as “first transfer”.

The first transfer roller 120 faces the developing device 110 across the intermediate transfer belt 131, and brings the outer peripheral surface of the intermediate transfer belt 131 into contact with the developing device 110.

The first transfer roller 120 is provided for each of developing devices 110Y, 110M, 110C, and 110K. In FIG. 3, the first transfer rollers 120 corresponding to the individual colors are represented by “120Y”, “120M”, “120C”, and “120K”.

In FIG. 3, the intermediate transfer belt 131 moves in an arrow direction (i.e., counterclockwise). The intermediate transfer belt 131 is moved by, for example, either one or both of the drive rollers 132 and 133.

In FIG. 3, toner images are firstly transferred onto the outer peripheral surface of the intermediate transfer belt 131. That is, the intermediate transfer belt 131 carries toner images corresponding to the individual colors. The outer peripheral surface of the intermediate transfer belt 131 is hereinafter referred to as “transfer surface”.

In the configuration illustrated in FIG. 3, yellow, magenta, cyan, and black layers are stacked in this order from the bottom on the transfer surface of the intermediate transfer belt 131. That is, the transfer surface carries a multicolor toner image.

The backup roller 140 brings the transfer surface of the intermediate transfer belt 131 into contact with the recording medium to transfer the toner image carried by the transfer surface onto the surface of the recording medium. The transfer performed by the backup roller 140 is referred to as “second transfer”.

In the second transfer, a predetermined voltage is applied to the backup roller 140. Through the voltage application, an electric field (hereinafter referred to as “transfer field”) is generated between the backup roller 140 and the recording medium, and the toner image formed by using charged toner is transferred onto the surface of the recording medium.

Thus, a current flows from the backup roller 140 to the recording medium via the intermediate transfer belt 131 to transfer the image from the intermediate transfer belt 131 to the recording medium.

In a case where the recording medium is a non-conductor, a conductive layer is formed on the recording medium in advance to secure a current path.

The cleaning device 150 is provided between the transfer position and the developing device 110Y on its downstream side. In other words, the cleaning device 150 is provided on a downstream side of the transfer position and on an upstream side of the developing device 110Y.

The cleaning device 150 removes residual toner to prepare for the next transfer cycle. That is, a new toner image may be transferred onto the transfer surface.

### <Configuration of Heating Apparatus>

FIG. 4 illustrates an example of the configuration of the heating apparatus 20.

The heating apparatus 20 has an opening 201 on the side for connection to the internal space of the transfer apparatus 10 (see FIG. 1), and has an opening 202 on the side for connection to the entry/exit room 30 (see FIG. 1).

A heat source 220 is disposed in an upper space of the heating apparatus 20. The heat source 220 is an example of a light source in a broad sense.

In this exemplary embodiment, the heat source 220 is compatible with two types of heating method for heating the recording medium in a non-contact manner. The heating method to be used for fixing a toner image may be switched depending on the material of the recording medium.

In this exemplary embodiment, the heat source 220 is compatible with the infrared method using infrared rays to heat the recording medium onto which the toner image is transferred, and the far-infrared method using far-infrared rays to heat the recording medium onto which the toner image is transferred.

In this exemplary embodiment, the heat source 220 includes infrared radiation lamps and a movable black plate. The black plate absorbs infrared rays and emits far-infrared rays. The black plate is made of, for example, a ceramic.

If the black plate is moved to a position where the black plate does not block a radiation path of infrared rays, the heat source 220 operates by the infrared method. If the black plate is inserted to a position where the black plate blocks the radiation path of infrared rays, the heat source 220 operates by the far-infrared method.

The heating methods are switched under control of the control panel 40 (see FIG. 1). For example, if the material is metal, the control panel 40 uses the infrared method as the heating method. If the material is ceramic, glass, or cloth, the control panel 40 uses the far-infrared method as the heating method.

The transport rail 300 is attached between the openings 201 and 202. The transport mechanism 310 is attached to the transport rail 300 to transport a recording medium M.

In FIG. 4, the transport mechanism 310 includes a holder 311 that holds the recording medium M, and a lift mechanism 312. The lift mechanism 312 is movable in the horizontal direction along the transport rail 300. The lift mechanism 312 is an example of an adjustment mechanism that adjusts a distance in a height direction between the heat source 220 and the recording medium M.

The lift mechanism 312 is horizontally moved, for example, by a self-traveling mechanism provided to the lift mechanism 312 or by traction using a motor or any other drive mechanism provided to the transport rail 300.

In FIG. 4, the lift mechanism 312 includes, for example, a rod-shaped gear 312A called “rack” (i.e., a rack gear), a circular gear 312B (i.e., a pinion) that meshes with the gear 312A, a motor (not illustrated) that applies a rotational force to the circular gear 312B, a tubular member 312C to which the rod-shaped gear 312A is attached on its inner peripheral surface, a guide member 312D that guides the tubular member 312C along its inner peripheral surface, and a stage 312E movably attached to the transport rail 300.

The lower surface of the guide member 312D is attached to the upper surface of the stage 312E. The upper surface of the guide member 312D is not attached to any member. That is, the guide member 312D is not attached to the lower surface of the holder 311.

The motor (not illustrated) is attached to the upper surface of the stage 312E via a support member (not illustrated). The height position of the circular gear 312B is fixed relative to the upper surface of the stage 312E. Therefore, when the circular gear 312B rotates, the rod-shaped gear 312A and the tubular member 312C ascend or descend together. The upper surface of the tubular member 312C is attached to the lower surface of the holder 311. Therefore, the holder 311 ascends or descends in conjunction with the ascent or descent of the tubular member 312C. The recording medium M ascends or descends when the holder 311 ascends or descends.

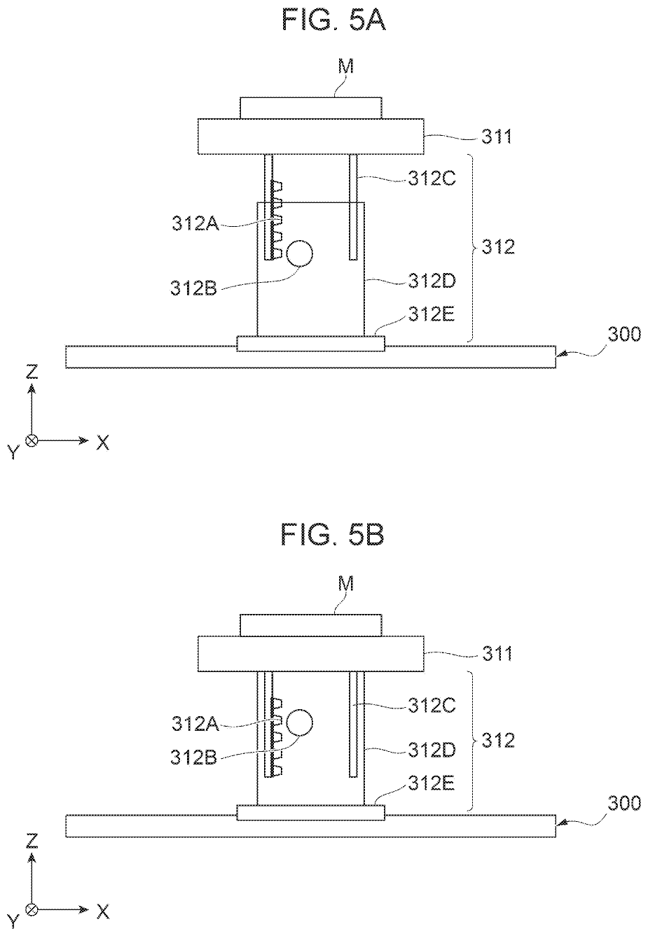

FIGS. 5A and 5B illustrate the ascent and descent of the holder 311. FIG. 5A illustrates the holder 311 that has ascended to the highest point. FIG. 5B illustrates the holder 311 that has descended to the lowest point. In FIGS. 5A and 5B, parts corresponding to those in FIG. 4 are represented by corresponding symbols.

In this exemplary embodiment, the lift mechanism 312 causes the holder 311 to ascend or descend under control of the processor 401 (see FIG. 2).

The recording medium M may directly be attached to the upper surface of the holder 311 (i.e., an attachment surface), or a jig (not illustrated) may be attached to the attachment surface. The jig may be attached to or detached from the attachment surface of the holder 311.

### <Jig for Attachment of Cylindrical Recording Medium>

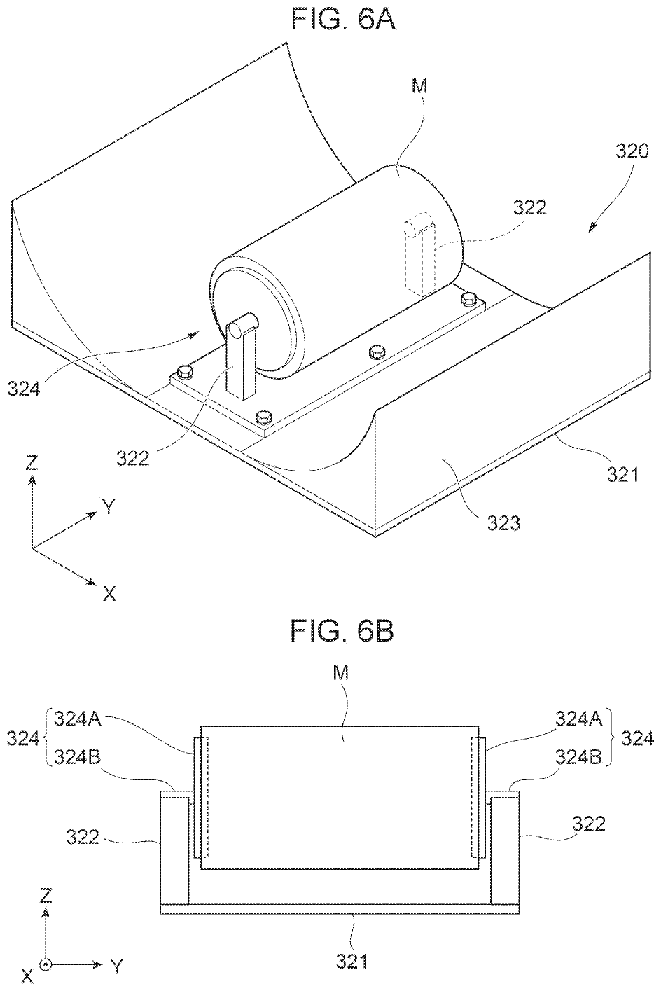

FIGS. 6A and 6B illustrate an example of a jig 320 for attachment of a cylindrical recording medium M. FIG. 6A is a perspective view illustrating the attached recording medium M. FIG. 6B is a side view illustrating the attached recording medium M. The lower surface of the jig 320 is attached to the upper surface (i.e., the attachment surface) of the holder 311 (see FIG. 4).

In FIGS. 6A and 6B, the jig 320 includes a base 321, support members 322, and reflection mirrors 323.

The base 321 is a flat plate member removably attached to the upper surface (i.e., the attachment surface) of the holder 311 (see FIG. 4).

The support member 322 supports the recording medium M out of contact with the upper surface of the base 321, and is attached to the upper surface of the base 321.

In this exemplary embodiment, two support members 322 are attached to the base 321. The two support members 322 are attached at both end positions of the base 321 in a Y-axis direction. The distance between the two support members 322 is set based on the length of the recording medium M in the Y-axis direction. In FIGS. 6A and 6B, the upper end surface of the support member 322 has a groove for rotatably supporting a protrusion 324B of another jig 324 attached to the recording medium. In FIGS. 6A and 6B, the shape of the groove cut along an XZ plane is a substantial U-shape or a substantial semicircular shape.

In FIGS. 6A and 6B, the support member 322 is a columnar member and is attached to the upper surface of the base 321 perpendicularly (i.e., in the Z-axis direction).

In FIGS. 6A and 6B, the support member 322 is screwed to the base 321. The support member 322 may be integrated with the base 321.

The reflection mirror 323 is a concave mirror attached to the upper surface of the base 321. The reflection mirror 323 is an example of a reflection member that reflects infrared rays or far-infrared rays radiated from the heat source 220 (see FIG. 4).

The reflection surface of the reflection mirror 323 is designed into such a shape that the infrared rays or the far-infrared rays reflected by the reflection surface may illuminate the lower surface (or the bottom surface) of the recording medium M supported by the support members 322.

In this exemplary embodiment, the lower surface of the cylindrical recording medium M refers to a part below the height position of a rotational symmetry axis of the recording medium M in the outer peripheral surface of the recording medium M supported by the support members 322. The lower surface of the recording medium M may be defined as a part that is not directly irradiated with the infrared rays or the far-infrared rays from the heat source 220 in the outer peripheral surface of the recording medium M.

In this exemplary embodiment, the reflection surface of the reflection mirror 323 is designed such that the infrared rays or the far-infrared rays reflected by the reflection surface may illuminate not only the lower surface of the recording medium supported by the support members 322 but also the side surfaces and a part of the upper surface. The upper surface of the recording medium refers to a part above the height of the rotational symmetry axis of the recording medium supported by the jig 320. The side surface of the recording medium M refers to a part near the height of the rotational symmetry axis of the recording medium M supported by the jig 320. The side surface of the recording medium M may include a part below the height of the rotational symmetry axis of the recording medium M if the part is near the height of the rotational symmetry axis.

The reflection surface of the reflection mirror 323 may have a single curvature or a plurality of curvatures.

The phrase “plurality of curvatures” means that the reflection surface of one of the reflection mirrors 323 across the support members 322 includes a plurality of curved surfaces different in curvature. For example, in a case of two curvatures, the curvature radius of the upper reflection surface may be larger than the curvature radius of the lower curved surface.

In this exemplary embodiment, the shape of the reflection surface of the reflection mirror 323 cut along the XZ plane is represented entirely by a curve, but may have a composite structure including a plurality of linear parts. In other words, the reflection mirror 323 may be an aggregate of a plurality of planar reflection surfaces. The reflection mirror 323 may have a composite structure including a linear part and a curved part.

For example, aluminum is used for the reflection surface of the reflection mirror 323. Aluminum has a characteristic to reflect the infrared rays or the far-infrared rays.

In FIG. 6B, the reflection mirrors 323 are omitted for convenience of description.

In the attachment example illustrated in FIGS. 6A and 6B, the other jigs 324 are attached to the right and left sides of the cylindrical recording medium M. The other jigs 324 are used for rotatably attaching the recording medium M to the support members 322. The other jigs 324 may be attached to or detached from the recording medium M.

The other jig 324 includes a disc 324A and a columnar protrusion 324B. The disc 324A is attached to an opening or recess of the recording medium M. The protrusion 324B is attached to the center of the disc 324A.

The protrusion 324B is rotatably supported in the groove of the upper end surface of the support member 322. The protrusion 324B serves as a rotation shaft to rotate the recording medium M in conjunction with the movement of the intermediate transfer belt 131 (see FIG. 3). Through the rotation of the protrusion 324B, the toner image may be transferred onto the outer peripheral surface of the recording medium M.

### <Recording Medium Setting Screen>

Description is made about a screen for setting information on the recording medium M prior to the transfer and fixing of the toner image. The operation screen is an example of a user interface screen.

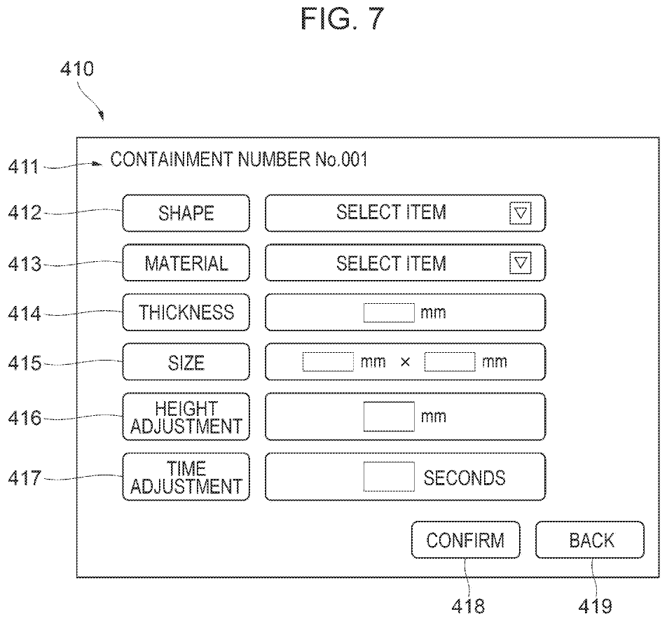

FIG. 7 illustrates an example of a setting screen 410 for the recording medium M that is displayed on the display 405 (see FIG. 2) of the control panel 40 (see FIG. 1).

In FIG. 7, the setting screen 410 is a new registration screen. In FIG. 7, information 411 for identifying a containment number is “No. 001”. The containment number is updated every time new registration is made. The containment number may be edited by a user.

The setting screen 410 includes a shape field 412, a material field 413, a thickness field 414, and a size field 415 for the recording medium M, a height adjustment field 416, a time adjustment field 417, a “confirm” button 418, and a “back” button 419.

A type of shape is input to the shape field 412. Examples of the type of shape in this exemplary embodiment include “flat plate”, “box”, and “can”. In the shape field 412 illustrated in FIG. 7, the selectable types of shape are displayed, for example, in a pull-down menu. In FIG. 7, the type of shape has not been selected. Therefore, a message “Select item” is displayed in the corresponding input field.

The material of the recording medium M is input to the material field 413. Examples of the material in this exemplary embodiment include “stainless steel”, “aluminum”, “ceramic”, “glass”, and “cloth”. In the material field 413 illustrated in FIG. 7, the selectable materials are displayed, for example, in a pull-down menu. In FIG. 7, the material has not been selected. Therefore, a message “Select item” is displayed in the corresponding input field.

The length of the recording medium M in the Z-axis direction (i.e., a thickness T) is input to the thickness field 414. In FIG. 7, the unit is millimeter. In this exemplary embodiment, the thickness may be input within a range of 0 mm to 100 mm.

In a case where the recording medium M is attached to the attachment surface of the holder 311 (see FIG. 4) by using the jig, a value obtained by adding the thickness of the jig to the thickness T of the recording medium M is input to the thickness field 414.

If the height of the holder 311 is set based on the thickness of the recording medium M alone, the actual distance between the recording medium M and the heat source 220 is shorter than the calculated distance by the thickness of the jig and the recording medium M is closer to the heat source 220 (see FIG. 4). As a result, the temperature of the recording medium M may excessively increase to cause a fixing failure.

The fixing failure based on this cause may occur also in a case where the recording medium M is supported while the bottom surface of the recording medium M is out of contact with the “jig for attachment of recording medium M” or the “attachment surface”.

In this case, a value obtained by adding the thickness of the jig or the height of a gap from the jig to the thickness T of the recording medium M is input to the thickness field 414.

If a height sensor (not illustrated) is provided to the heating apparatus 20 (see FIG. 1) or the entry/exit room 30 (see FIG. 1) to measure a distance in the Z-axis direction between the uppermost surface of the recording medium M and the attachment surface, the processor 401 may display the measured numerical value in the thickness field 414. In this case, the thickness field 414 may be omitted from the setting screen 410.

If the height sensor (not illustrated) measures the distance between the heat source 220 (see FIG. 4) and the recording medium M, the thickness T of the recording medium M may be calculated by using information on the height of the attachment surface at the time of measurement.

If an input field for information for identifying the jig to be used is provided or the thickness of the jig is set as an initial value, the processor 401 may add, to the actual thickness T of the recording medium M, a correction value corresponding to the thickness of the jig or the gap from the jig.

The length of the recording medium M in the X-axis direction (i.e., a width W) and the length of the recording medium M in the Y-axis direction (i.e., a depth D) are input to the size field 415. In FIG. 7, the width W is input to a left input field and the depth D is input to a right input field. In FIG. 7, the unit is millimeter.

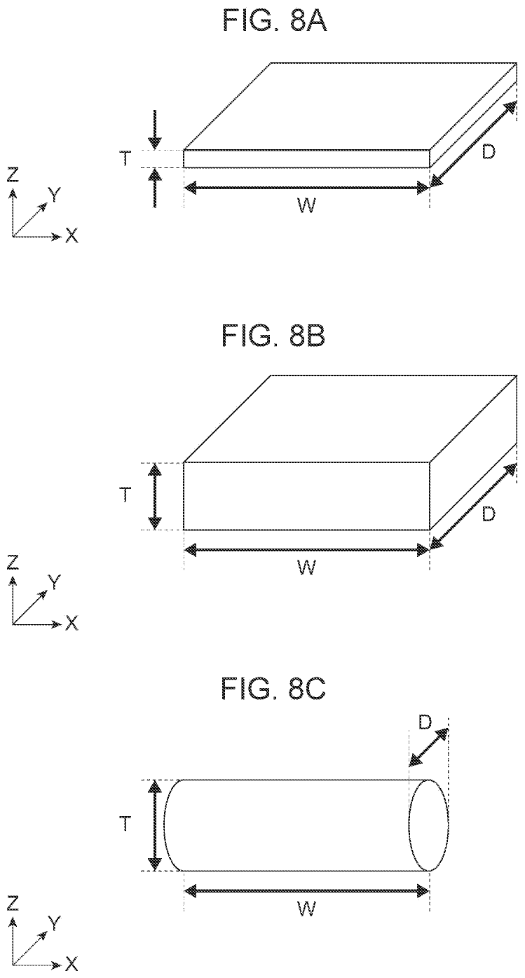

FIGS. 8A to 8C illustrate relationships among the thickness T, the width W, and the depth D for individual types of shape. FIG. 8A illustrates a flat plate. FIG. 8B illustrates a box. FIG. 8C illustrates a can. In a case of a cylindrical can, the thickness T and the depth D have the same value.

The height adjustment field 416 is used for adjusting the height of the holder 311 determined based on a numerical value input by the user (i.e., a recommended value or an initial value). In other words, the height adjustment field 416 is used for adjusting the fixing quality. The numerical value input to the height adjustment field 416 is an example of an adjustment amount. The height serving as the recommended value is set by the processor 401 (see FIG. 2).

In FIG. 7, the unit in the height adjustment field 416 is millimeter. In this exemplary embodiment, the height may be adjusted within a range of ±20 mm.

A positive numerical value means ascent of the attachment surface compared with the recommended value. In other words, this value provides an effect that the thickness of the recording medium M is reduced from the actual thickness.

A negative numerical value means descent of the attachment surface compared with the recommended value. In other words, this value provides an effect that the thickness of the recording medium M is increased from the actual thickness.

The time adjustment field 417 is used for adjusting a heating period set by the processor 401. The heating period is set by the processor 401 based on a combination of the material of the recording medium M and the heating method. In FIG. 7, the unit is second. In this exemplary embodiment, the heating period may be adjusted within a range of ±60 seconds. Through the heating period adjustment, the fixing quality of the toner image may be adjusted.

The “confirm” button 418 is used for confirming the input items and registering them in association with the containment number.

The “back” button 419 is used for returning to a previous operation screen. In response to operation on the “back” button 419, the input items are canceled.

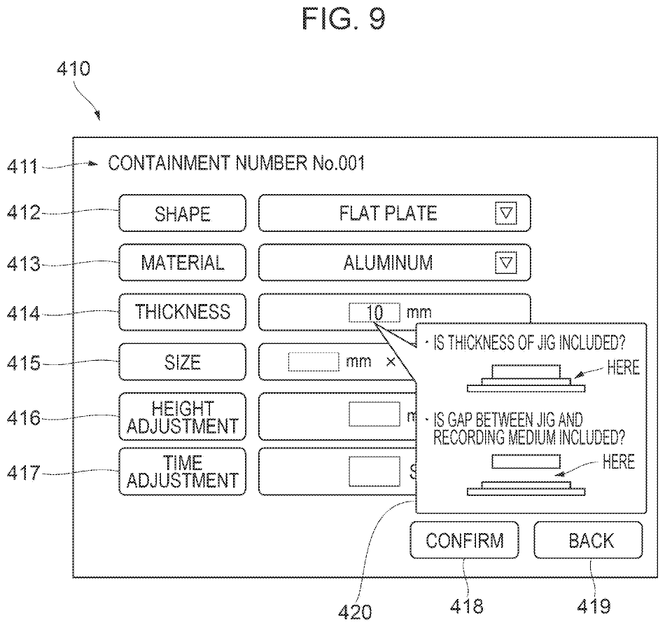

FIG. 9 illustrates an example of the setting screen during input. In FIG. 9, parts corresponding to those in FIG. 7 are represented by corresponding symbols.

In FIG. 9, “flat plate” is input to the shape field 412, “aluminum” is input to the material field 413, and “10 mm” is input to the thickness field 414.

In FIG. 9, a pop-up screen 420 is displayed in association with the input field of the thickness field 414. The pop-up screen 420 illustrated in FIG. 9 is an example of information for assisting the user in inputting the thickness of the recording medium M. The pop-up screen 420 is displayed during the input of the numerical value of the thickness T, after the input of the numerical value, or during and after the input. The pop-up screen 420 is displayed under control of the processor 401. The display of the pop-up screen 420 may be a requisite. The display of the pop-up screen 420 may be stopped if the user does not want the display of the pop-up screen 420 or the correction value corresponding to the thickness of the jig or the gap is registered.

In FIG. 9, two items are displayed in the pop-up screen 420.

The first item is to suggest the input of a numerical value including the thickness of the jig as well as the thickness of the recording medium M in the thickness field 414.

The second item is to suggest the input of a numerical value including the distance of the gap between the recording medium M and the jig as well as the thickness of the recording medium M in the thickness field 414.

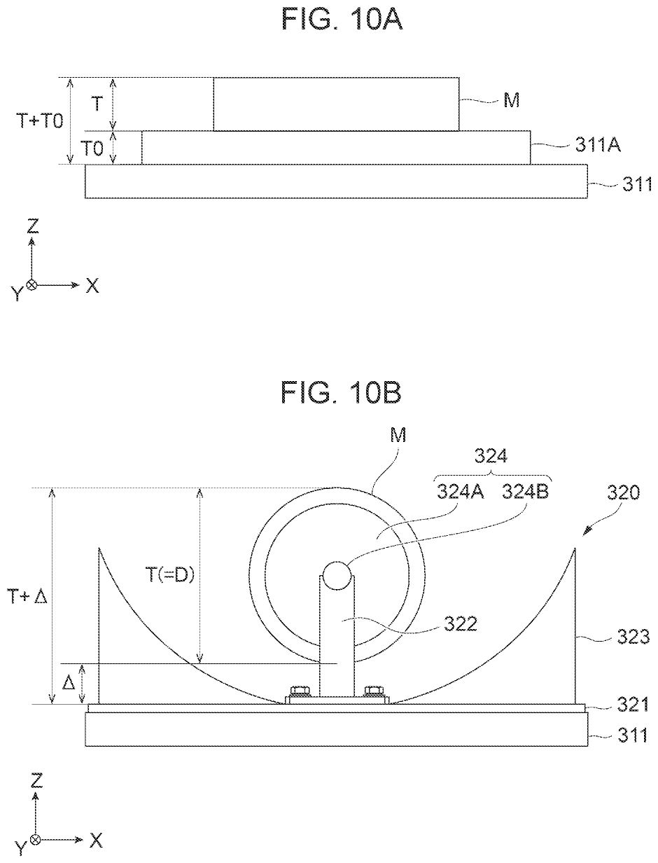

FIGS. 10A and 10B illustrate the items suggested in the pop-up screen 420. FIG. 10A illustrates a case where there is no gap between the recording medium M and the surface of a jig 311A. FIG. 10B illustrates a case where there is a gap between the recording medium M and the surface of the jig 320. In FIGS. 10A and 10B, parts corresponding to those in FIG. 4 and FIGS. 6A and 6B are represented by corresponding symbols.

In the attachment illustrated in FIG. 10A, a numerical value obtained by adding a thickness TO of the jig 311A to the thickness T of the recording medium M (=T+T0) is input to the thickness field 414 (see FIG. 9) as an apparent thickness.

In the attachment example illustrated in FIG. 10B, the recording medium M is supported out of contact with the base 321 by the support members 322 of the jig 320. In FIG. 10B, the thickness of the base 321 is included as a gap A between the surface of the base 321 and the lowermost point of the recording medium M. In this case, a numerical value obtained by adding the gap A to the thickness T of the recording medium M (=T+Δ) is input to the thickness field 414 (see FIG. 9) as the apparent thickness.

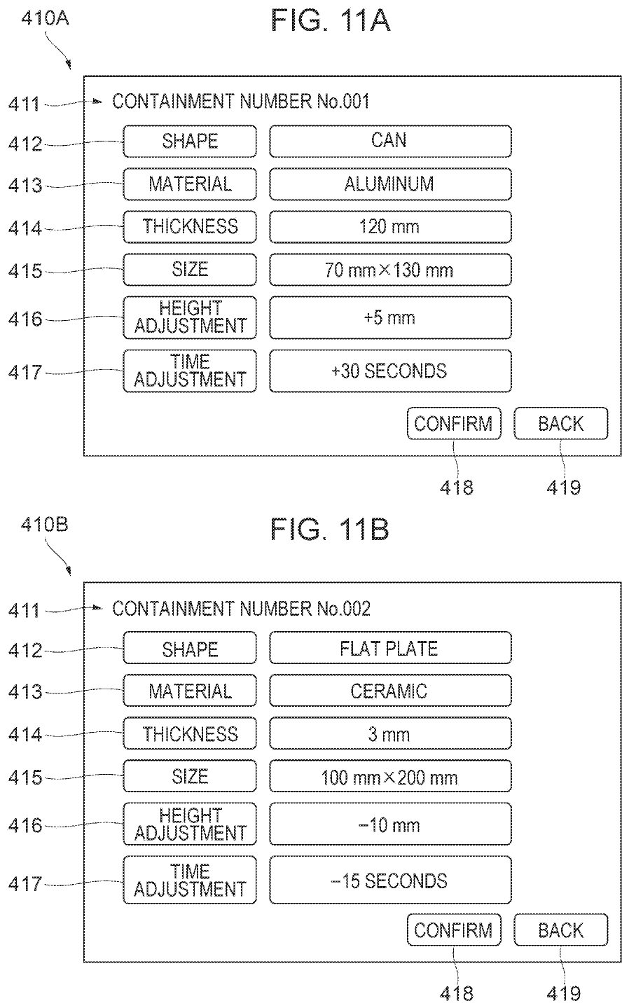

FIGS. 11A and 11B illustrate examples of input to the setting screen 410. FIG. 11A illustrates an input example in a case where the recording medium M is an aluminum can. FIG. 11B illustrates an input example in a case where the recording medium M is a ceramic flat plate. In FIGS. 11A and 11B, parts corresponding to those in FIG. 7 are represented by corresponding symbols.

A setting screen 410A illustrated in FIG. 11A shows a setting example for an aluminum can having a thickness T of 120 mm, a width W of 70 mm, and a depth D of 130 mm. The setting screen 410A shows that the height of the attachment surface is increased by 5 mm from the recommended value and the heating period is increased by 30 seconds from a standard value.

A setting screen 410B illustrated in FIG. 11B shows a setting example for a ceramic flat plate having a thickness T of 3 mm, a width W of 100 mm, and a depth D of 200 mm. The setting screen 410B shows that the height of the attachment surface is reduced by 10 mm from the recommended value and the heating period is reduced by 15 seconds from the standard value.

### <Setting of Height of Holder 311 for Fixing Step>

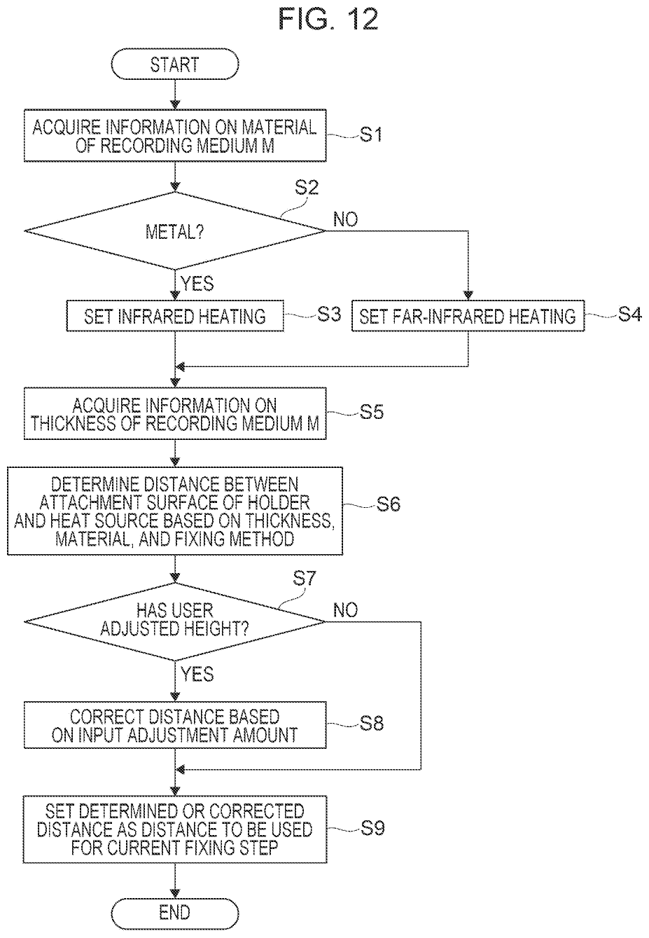

FIG. 12 is a flowchart illustrating setting of the height of the holder 311 (see FIG. 4) by the processor 401 (see FIG. 2). The height of the holder 311 means the height of the attachment surface for the recording medium M. In FIG. 12, the symbol “S” means “step”.

In FIG. 12, the processing operation is performed before the start of the first fixing of the toner image at the latest. In this exemplary embodiment, the processing operation illustrated in FIG. 12 is performed after information on the recording medium M to be processed has been set in the image forming system 1.

The processor 401 acquires information on the material of the recording medium M (Step 1). When the information is acquired, the processor 401 determines whether the material is metal (Step 2). The metal is stainless steel or aluminum to be processed by the image forming system 1 (see FIG. 1).

If the material of the recording medium M is stainless steel or aluminum, the result is “YES” in Step 2. In this case, the processor 401 sets infrared heating (Step 3).

If the material of the recording medium M is ceramic, glass, or cloth, the result is “NO” in Step 2. In this case, the processor 401 sets far-infrared heating (Step 4).

After Step 3 or 4, the processor 401 acquires information on the thickness T of the recording medium M (Step 5).

As described above, the thickness T may be the thickness of the recording medium M or include the thickness of the jig or the distance of the gap between the lowermost point of the recording medium M and the attachment surface. In this exemplary embodiment, the processor 401 acquires a numerical value input to the thickness field 414 (see FIG. 7) of the setting screen 410 (see FIG. 7).

If the sensor (not illustrated) measures the distance between the uppermost point of the recording medium M and the attachment surface as described above, the measured numerical value is used. If the thickness TO of the jig (see FIGS. 10A and 10B) or the gap A is given as the initial value, the processor 401 sets the thickness of the recording medium M to a value obtained by adding this numerical value to the value in the thickness field 414 (see FIG. 7).

When the information on the thickness T is acquired, the processor 401 determines the distance between the attachment surface of the holder 311 (see FIG. 4) and the heat source 220 (see FIG. 4) based on the thickness, the material, and the heating method (Step 6).

The following calculation formulae are used to calculate the distance.

### Infrared Heating Method

$$Y = 0.85 * X + 148$$

### Far-Infrared Heating Method

$$Y = 0.68 * X + 98$$

In the formulae, Y represents the distance from the heat source 220 to the attachment surface for the recording medium M, and X represents the thickness of the recording medium M. The thickness is the numerical value acquired in Step 5.

The calculation formulae are examples.

The distance may be read from a table based on the processing target.

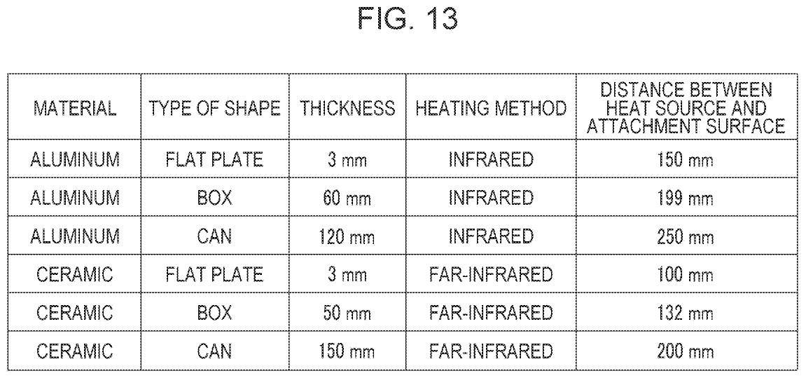

FIG. 13 illustrates an example of a table that records relationships between combinations of the thickness and material of the recording medium M and distances from the heat source to the attachment surface.

In the table illustrated in FIG. 13, the recommended value of the distance between the heat source and the attachment surface is associated with a combination of the material, the type of shape, the thickness, and the heating method.

If the combination of the thickness and material of the recording medium M input to the setting screen 410 (see FIG. 7) is not present in the table illustrated in FIG. 13, the distance may be calculated, for example, by linear interpolation based on the input thickness, or by using the calculation formulae described above.

When the distance from the heat source 220 to the attachment surface is determined, the processor 401 determines whether the user has adjusted the height (Step 7).

If a numerical value other than zero is input to the height adjustment field 416 (see FIG. 7), the result is “YES” in Step 7. If zero is input to the height adjustment field 416 (see FIG. 7), the result is “NO” in Step 7.

If the result is “YES” in Step 7, the processor 401 corrects the distance based on the input adjustment amount (Step 8).

After the distance is corrected in Step 8 or if the result is “NO” in Step 7, the processor 401 sets the determined or corrected distance as a distance to be used for the current fixing step (Step 9).

Through the process described above, the setting of the height of the holder 311 for the fixing step is completed.

### <Control in Fixing Step>

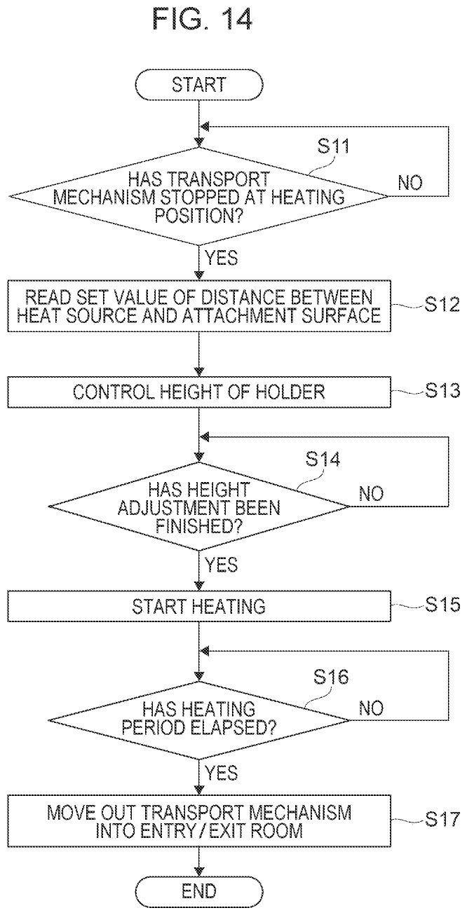

FIG. 14 is a flowchart illustrating an example of control in the fixing step.

The step of transferring a toner image onto the surface of the recording medium M (i.e., the transfer step) is performed before the start of the fixing step illustrated in FIG. 14. In this exemplary embodiment, the recording medium M onto which the toner image has been transferred is transported to the heating apparatus 20 (see FIG. 1) while being held by the holder 311 (see FIG. 4). The processing operation illustrated in FIG. 14 is started in response to detection of entry of the holder 311 into the heating apparatus 20.

The processor 401 determines whether the transport mechanism 310 has stopped at a heating position (Step 11). The heating position is directly below the heat source 220.

If the transport mechanism 310 has not stopped at the heating position, the result is “NO” in Step 11. In this case, the processor 401 repeats the determination in Step 11.

If the transport mechanism 310 has stopped at the heating position, the result is “YES” in Step 11. In this case, the processor 401 reads a set value of the distance between the heat source 220 and the attachment surface. The set value is the numerical value set in Step 9 (see FIG. 12).

The processor 401 controls the height of the holder 311 (Step 13). That is, the processor 401 controls the lift mechanism 312 (see FIG. 4) so that the height of the attachment surface of the holder 311 satisfies the set value.

The processor 401 determines whether the height adjustment has been finished (Step 14).

If the height adjustment has not been finished, the result is “NO” in Step 14. In this case, the processor 401 repeats the determination in Step 14.

If the height adjustment has been finished, the result is “YES” in Step 14. In this case, the processor 401 starts heating (Step 15). Specifically, the radiation of infrared rays or far-infrared rays is started. Measurement of the heating period is started simultaneously with the start of the radiation of infrared rays or far-infrared rays.

The processor 401 determines whether the heating period has elapsed (Step 16).

If the heating period has not elapsed, the result is “NO” in Step 16. In this case, the processor 401 repeats the determination in Step 16.

If the heating period has elapsed, the result is “YES” in Step 16. In this case, the processor 401 moves out the transport mechanism into the entry/exit room 30 (see FIG. 1) (Step 17). The recording medium M is cooled for a preset period in the entry/exit room 30.

### Second Exemplary Embodiment

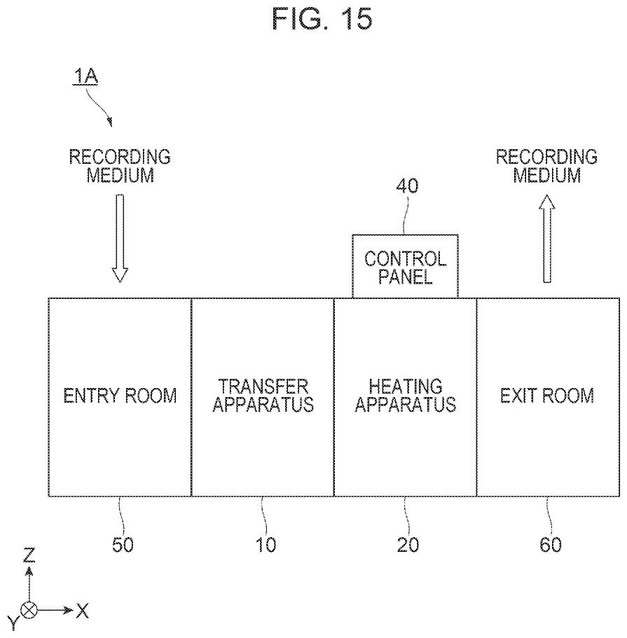

FIG. 15 illustrates the overall configuration of an image forming system 1A of a second exemplary embodiment. In FIG. 15, parts corresponding to those in FIG. 1 are represented by corresponding symbols.

In the image forming system 1A illustrated in FIG. 15, an entry room 50 and an exit room 60 are used in place of the entry/exit room 30.

In the image forming system 1A illustrated in FIG. 15, the recording medium M that has entered the entry room 50 is transported to the adjacent transfer apparatus 10. The recording medium M onto which a toner image has been transferred by the transfer apparatus 10 is transport to the exit room 60 through the heating apparatus 20 and exits to the outside. In this case, the recording medium M is moved in one direction.

### Other Exemplary Embodiments

(1) Although the exemplary embodiments of the present disclosure have been described above, the technical scope disclosed herein is not limited to the scope described in the above exemplary embodiments. It is apparent that the technical scope disclosed herein includes various modifications or revisions of the above exemplary embodiments from the description of the claims.

(2) In the above exemplary embodiments, the heating apparatus 20 (see FIG. 1) handles the two types of heating method. The heating apparatus 20 may handle one heating method alone. For example, the heating apparatus 20 may be dedicated to the infrared method, may be dedicated to the far-infrared method, may heat the recording medium by hot air, or may heat the recording medium by convection heat (so-called oven).

In this case, the toner image is fixed by using a heating apparatus that may handle the material of the recording medium. For example, a heating apparatus dedicated to the infrared method is used for fixing the toner image onto metal. A heating apparatus dedicated to the far-infrared method, a heating apparatus dedicated to a toner image fixing method using hot air (hereinafter referred to as “hot air method”), and a heating apparatus dedicated to a toner image fixing method using convection heat (hereinafter referred to as “oven method”) are used for fixing the toner image onto glass, ceramic, or cloth. In the case where the heating apparatus handles one heating method, the height of the holder 311 is controlled based on the thickness of the recording medium.

(3) In the above exemplary embodiments, the heating apparatus 20 (see FIG. 1) switches the infrared method and the far-infrared method, but may switch a combination of other heating methods. For example, the heating apparatus 20 may switch the infrared method and the hot air method, or may switch the infrared method and the oven method.

The heating apparatus 20 may switch three or more types of heating method. For example, the heating apparatus 20 may switch the infrared method, the far-infrared method, and the hot air method, or may switch the infrared method, the far-infrared method, and the oven method.

In the case where the heating apparatus may switch a plurality of heating methods, the heating method and the height of the holder 311 are controlled based on the combination of the material and thickness of the recording medium.

(4) In the above exemplary embodiments, the entry/exit room 30 (see FIG. 1) has the opening on its top and the recording medium M enters and exits through the opening. The entry/exit room 30 may have the opening on its side.

(5) In the above exemplary embodiments, the transport mechanism 310 (see FIG. 4) is moved along the transport rail 300 (see FIG. 4). The transport mechanism 310 may be moved by a belt conveyor.

(6) In the above exemplary embodiments, the image forming system 1 (see FIG. 1) or the like is constituted by combining the heating apparatus 20 with the transfer apparatus 10 and the like. The heating apparatus 20 may be used separately from the transfer apparatus 10.

(7) In the above exemplary embodiments, the setting screen 410 includes the material field 413 and the thickness field 414. The material field 413 may be omitted in a case where the heating apparatus 20 handles one type of heating method alone.

(8) In the above exemplary embodiments, the height of the holder 311 is set based on the combination of the thickness T and the material of the recording medium M (or the heating method). In a case where the heating apparatus 20 is dedicated to a specific heating method, the height of the holder 311 may be set based on the thickness T of the recording medium M alone. If the thickness T of the recording medium M is known or fixed, the height of the holder 311 may be set based on the material of the recording medium M (or the heating method) alone.

Even if the information on the thickness T of the recording medium M is unknown, the height of the holder 311 may be set based on a combination of the material (or the heating method) and information on the type of the shape of the recording medium M. In this case, the height of the holder 311 may be set by referring to a database including past records.

(9) In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

A heating system comprising:
a heat source configured to heat, in a non-contact manner, an object onto which a toner image has been transferred;
a holder configured to hold the object;
an adjustment mechanism configured to adjust a distance in a height direction between the heat source and the object; and
one or more processors configured to control the adjustment mechanism,
wherein the one or more processors are configured to control a height of the holder based on at least one of a thickness or a material of the object prior to heating of the object by the heat source.

(((2)))

The heating system according to (((1))), wherein the one or more processors are configured to use the adjustment mechanism to control the height of the holder that holds the object.

(((3)))

The heating system according to (((1))) or (((2))), wherein the one or more processors are configured to control the height of the holder based on a numerical value preset about at least one of the thickness or the material of the object.

(((4)))

The heating system according to (((3))), wherein the one or more processors are configured to, when an adjustment amount of the height has been received via a user interface screen, correct the numerical value based on the adjustment amount, and control the height of the holder based on the corrected numerical value.

(((5)))

The heating system according to (((3))), wherein the one or more processors are configured to receive at least one of a numerical value on the thickness of the object or information on the material of the object via a user interface screen.

(((6)))

The heating system according to (((3))), wherein the one or more processors are configured to, if a gap is present between a bottom of the object held by the holder and a surface of the holder, use a value obtained by adding a correction value corresponding to the gap to an actual thickness of the object as the thickness of the object.

(((7)))

The heating system according to any one of (((1))) to (((6))), wherein the one or more processors are configured to, when a numerical value indicating the thickness of the object is received or has been received via a user interface screen, present information for assisting input of a numerical value including a thickness of a jig for attachment to an attachment surface of the holder.

(((8)))

The heating system according to any one of (((1))) to (((6))), wherein the one or more processors are configured to, when a numerical value indicating the thickness of the object is received or has been received via a user interface screen, present information for assisting input of a numerical value including a distance of a gap between a bottom surface of the object and a jig for attachment to an attachment surface of the holder.

(((9)))

An image forming system comprising:
a transport mechanism configured to transport a holder that holds an object;
a transfer apparatus configured to transfer a toner image onto the object held by the holder; and
a heating system configured to heat the object onto which the toner image has been transferred with the object held by the holder,
wherein the heating system is the heating system according to any one of (((1))) to (((8))).

What is claimed is:

1. A heating system comprising:
a heat source configured to heat, in a non-contact manner, an object onto which a toner image has been transferred;
a holder configured to hold the object;
an adjustment mechanism configured to adjust a distance in a height direction between the heat source and the object; and
one or more processors configured to control the adjustment mechanism,
wherein the one or more processors are configured to control a height of the holder based on at least one of a thickness or a material of the object prior to heating of the object by the heat source.

2. The heating system according to claim 1, wherein the one or more processors are configured to use the adjustment mechanism to control the height of the holder that holds the object.

3. The heating system according to claim 1, wherein the one or more processors are configured to control the height of the holder based on a numerical value preset about at least one of the thickness or the material of the object.

4. The heating system according to claim 3, wherein the one or more processors are configured to, when an adjustment amount of the height has been received via a user interface screen, correct the numerical value based on the adjustment amount, and control the height of the holder based on the corrected numerical value.

5. The heating system according to claim 3, wherein the one or more processors are configured to receive at least one of a numerical value on the thickness of the object or information on the material of the object via a user interface screen.

6. The heating system according to claim 3, wherein the one or more processors are configured to, if a gap is present between a bottom of the object held by the holder and a surface of the holder, use a value obtained by adding a correction value corresponding to the gap to an actual thickness of the object as the thickness of the object.

7. The heating system according to claim 1, wherein the one or more processors are configured to, when a numerical value indicating the thickness of the object is received or has been received via a user interface screen, present information for assisting input of a numerical value including a thickness of a jig for attachment to an attachment surface of the holder.

8. The heating system according to claim 1, wherein the one or more processors are configured to, when a numerical value indicating the thickness of the object is received or has been received via a user interface screen, present information for assisting input of a numerical value including a distance of a gap between a bottom surface of the object and a jig for attachment to an attachment surface of the holder.

9. An image forming system comprising:
a transport mechanism configured to transport a holder that holds an object;
a transfer apparatus configured to transfer a toner image onto the object held by the holder; and
a heating system configured to heat the object onto which the toner image has been transferred with the object held by the holder,
wherein the heating system is the heating system according to claim 1.

10. An image forming system comprising:
a transport mechanism configured to transport a holder that holds an object;
a transfer apparatus configured to transfer a toner image onto the object held by the holder; and
a heating system configured to heat the object onto which the toner image has been transferred with the object held by the holder,
wherein the heating system is the heating system according to claim 2.

11. An image forming system comprising:
a transport mechanism configured to transport a holder that holds an object;
a transfer apparatus configured to transfer a toner image onto the object held by the holder; and
a heating system configured to heat the object onto which the toner image has been transferred with the object held by the holder,
wherein the heating system is the heating system according to claim 3.

12. An image forming system comprising:
a transport mechanism configured to transport a holder that holds an object;
a transfer apparatus configured to transfer a toner image onto the object held by the holder; and
a heating system configured to heat the object onto which the toner image has been transferred with the object held by the holder,
wherein the heating system is the heating system according to claim 4.

13. An image forming system comprising:
a transport mechanism configured to transport a holder that holds an object;
a transfer apparatus configured to transfer a toner image onto the object held by the holder; and
a heating system configured to heat the object onto which the toner image has been transferred with the object held by the holder,
wherein the heating system is the heating system according to claim 5.

14. An image forming system comprising:
a transport mechanism configured to transport a holder that holds an object;
a transfer apparatus configured to transfer a toner image onto the object held by the holder; and
a heating system configured to heat the object onto which the toner image has been transferred with the object held by the holder,
wherein the heating system is the heating system according to claim 6.

15. An image forming system comprising:
a transport mechanism configured to transport a holder that holds an object;
a transfer apparatus configured to transfer a toner image onto the object held by the holder; and
a heating system configured to heat the object onto which the toner image has been transferred with the object held by the holder,
wherein the heating system is the heating system according to claim 7.

16. An image forming system comprising:
a transport mechanism configured to transport a holder that holds an object;
a transfer apparatus configured to transfer a toner image onto the object held by the holder; and
a heating system configured to heat the object onto which the toner image has been transferred with the object held by the holder,
wherein the heating system is the heating system according to claim 8.

17. A heating system comprising:
heating means for heating, in a non-contact manner, an object onto which a toner image has been transferred;
holding means for holding the object;
adjusting means for adjusting a distance in a height direction between the heating means and the object; and
control means for controlling the adjusting means,
wherein the control means controls a height of the holding means based on at least one of a thickness or a material of the object prior to heating of the object by the heating means.
